(19) United States
(12) Patent Application Publication
(10) Pub. No.: US 2026/0116350 A1
(43) Pub. Date: Apr. 30, 2026

(54) Cinematic Audio-Visual System For A Car Wash

(71) Applicant: Roaring Kitten, Inc, San Bruno, CA (US)

(72) Inventor: Bobak Cyrus Bakhtiari, Ann Arbor, MI (US)

(21) Appl. No.: 19/376,262

(22) Filed: Oct. 31, 2025

Related U.S. Application Data
(60) Provisional application No. 63/714,434, filed on Oct. 31, 2024.

(51) Int. Cl. B60S 3/04; G03B 21/12; G03B 21/56

(52) U.S. Cl. CPC B60S 3/04; G03B 21/12; G03B 21/565

(57) ABSTRACT

A carwash system and method of operating the carwash system for washing a vehicle is provided. The carwash system comprises a carwash bay, a visual projection assembly to project images and video, an audio output system to emit sound, a user interface having a content menu with a plurality of content selections, a washing unit to conduct a cleaning cycle, and a control unit. The control unit is operatively connected to the visual projection assembly, audio output system, user interface, and washing unit. The control unit synchronizes the visual projection assembly and audio output system with the cleaning cycle conducted by the washing unit based on a specific content selection received from a user input on the user interface.

### CROSS-REFERENCE TO RELATED APPLICATIONS

The subject patent application claims priority to and all the benefits of U.S. Provisional Patent Application No. 63/714,434, filed on Oct. 31, 2024, the disclosure of which is hereby incorporated by reference.

### BACKGROUND OF THE INVENTION

### 1. Field of Invention

The present disclosure relates generally to a cinematic audio-visual system for a car wash.

### 2. Description of the Related Art

Traditional carwash systems focus primarily on the mechanical and chemical processes of cleaning a vehicle, offering limited engagement or entertainment for the customer during the wash cycle. While some modern carwashes feature lighting or sound effects, these elements are typically limited in interactivity and personalization, offering a more basic experience compared to immersive alternatives.

There is a growing demand for enhanced customer experiences across service industries, including automotive care. In particular, carwash operators seek innovative ways to differentiate their services, increase customer retention, and generate additional revenue streams. The integration of multimedia elements-such as dynamic video projections and synchronized audio-offers a unique opportunity to transform the carwash from a routine task into an engaging, memorable event.

### SUMMARY OF THE INVENTION

The present disclosure is directed to a carwash system for washing a vehicle. The carwash system includes a carwash bay having a first wall, a second wall, a ceiling, an entrance area, and an exit area defining an interior space. The system also includes a visual projection assembly mounted to said carwash bay within said interior space to project images and video onto at least one of said first wall and said second wall within said interior space. An audio output system is mounted to said carwash bay to emit sound within said interior space. A user interface having a content menu with a plurality of content selections where the user interface is configured to receive an input indicative of a specific content selection from said content menu is also included in the system. A washing unit is mounted between said first wall and said second wall with said washing unit having a rest mode and a cleaning mode with at least a portion of said washing unit moving between said entrance area and said exit area when in the cleaning mode to conduct a cleaning cycle for washing the vehicle. The system additionally includes a control unit operatively connected to said visual projection assembly, said audio output system, said user interface, and said washing unit with said control unit synchronizing said visual projection assembly and said audio output system with said cleaning cycle based on said content selection from said input received on said user interface.

The visual projection assembly may project images and video and said audio output system emit sound prior to an initiation of said cleaning cycle. Additionally, or alternatively, said visual projection assembly may project images and video and said audio output system emit sound immediately upon receiving said input indicative of said specific content selection at said user interface. Said visual projection assembly may also project images and video and said audio output system emit sound while said washing unit is in said rest mode and prior to receiving the vehicle in the carwash bay for washing. Said control unit synchronizes said images and video with said sound while said washing unit is in said rest mode.

Said carwash system may be touchless with said washing unit having a plurality of sprayers to perform said cleaning cycle for washing the vehicle without physical contact. Said visual projection assembly may include one or more laser projectors with each of said one or more laser projectors enclosed within a housing having a ventilation conduit that extends externally to said carwash bay for circulating air flow and reducing moisture within said housing. Said housing of said one or more laser projectors may be mounted to said ceiling of said carwash bay. Said audio output system may include one or more speakers mounted to said ceiling of said carwash bay. The carwash system may additionally include an FM transmitter operatively connected to said audio output system for transmitting said sound to a receiver within the vehicle.

Said first wall and said second wall may have removable paneling to facilitate at least one of cleaning and replacement of wall surfaces to maintain clarity of projected images and video from said visual projection assembly. Said exit area may include an exit door with a display surface to present said images and video from said visual projection assembly. Said user interface may be at least one of a cellular device and a kiosk. Said plurality of content selections may include selectable themes including music genres, seasonal visuals, or promotional content. The carwash system may include a memory storage device integrated with said user interface to store said specific content selection of a user for future use.

A method of operating said carwash system for washing a vehicle is also provided. The method includes the step of receiving an input at the user interface indicative of a specific content selection from the plurality of content selections of the content menu, and the step of transmitting the input indicative of the content selection from the user interface to the control unit. The step of projecting images and video with the visual projection assembly onto at least one of the first wall and the second wall within the interior space based on the content selection is also included in the method, as well as the step of emitting sound with the audio output system based on the content selection. Further, the method includes the step of synchronizing with the control unit the images and video projected from the projection assembly and the sound emitted from the audio output system. The method also includes receiving a vehicle in the carwash bay. Finally, the method includes the step of conducting a cleaning cycle for washing the vehicle with at least a portion of the washing unit moving between the entrance area and the exit area when the cleaning mode of the washing unit is activated based on the content selection from the input at the user interface.

In the method, the steps of projecting images and video with the visual projection assembly and emitting sound with the audio output system may occur prior to the conducting of said cleaning cycle. Additionally, or alternatively, the steps of projecting images and video with the visual projection assembly and emitting sound with the audio output system may occur immediately upon receiving said input indicative of said specific content selection at said user interface. The steps of projecting images and video with the visual projection assembly and emitting sound with the audio output system may also occur prior to receiving the vehicle in the carwash bay and while the washing unit is in rest mode. The step of synchronizing with the control unit may further include synchronizing the cleaning cycle with the images and video projected from the projection assembly and the sound emitted from the audio output system. The method may include the step of transmitting with an FM transmitter the sound from the audio output system to a receiver within the vehicle.

Therefore, the system and method of the present disclosure offers a unique opportunity to transform a carwash from a routine task into an engaging, memorable event.

### BRIEF DESCRIPTION OF THE DRAWINGS

Advantages of the present invention will be readily appreciated as the same becomes better understood by reference to the following detailed description when considered in connection with the accompanying drawings.

FIG. 1 is a perspective view of a carwash system with a vehicle at a kiosk outside of a carwash bay.

FIG. 2 is a schematic view of a user interface.

FIG. 3A is a schematic view of a content menu on the user interface.

FIG. 3B is another schematic view of the content menu after a content selection is made.

FIG. 4 is a front view of an interior space of a carwash bay defined by a first wall, a second wall, an entrance area, and an exit area.

FIG. 5 is another front view of the interior space of the carwash bay with a vehicle therein.

FIG. 6 is the front view of the interior space of FIG. 4, with a cleaning cycle for washing the vehicle initiated.

FIG. 7 is the front view of the interior space of FIG. 4, with the vehicle exiting the interior space of the carwash bay via an exit door in the exit area.

FIG. 8 is a perspective view of an exit door for the exit area of the interior space of the carwash bay.

FIG. 9 is a front view of the first wall or the second wall of the carwash bay that defines the interior space.

FIG. 10 is a perspective view of an FM transmitter within a housing.

FIG. 11 is perspective view of an amplifier.

FIG. 12 is a flowchart of a method for operating the carwash system.

### DETAILED DESCRIPTION OF THE PREFERRED EMBODIMENT(S)

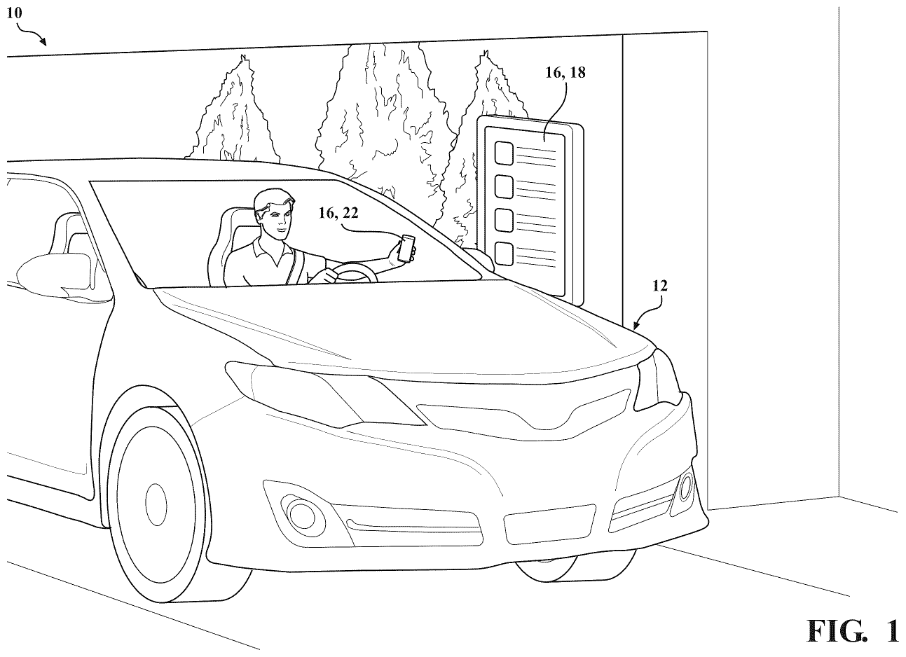

Referring to the Figures, wherein like numerals indicate like parts throughout the various views, FIG. 1 illustrates a portion of a carwash system 10 for washing a vehicle 12, wherein the vehicle 12 is positioned outside of a carwash bay 14 and proximate a user interface 16. Upon approaching the user interface 16, the system 10 may automatically detect the presence of the vehicle 12 using one or more proximity sensors, motion detectors, or license plate recognition cameras. These sensors may be mounted near the entrance of the carwash bay 14 or integrated into the user interface 16. Additionally, detection of the vehicle 12 may trigger system wake-up protocols or activate the user interface 16 for interaction. In some embodiments, the system 10 may also initiate a preloading of a user's preferences based on license plate data or user account recognition.

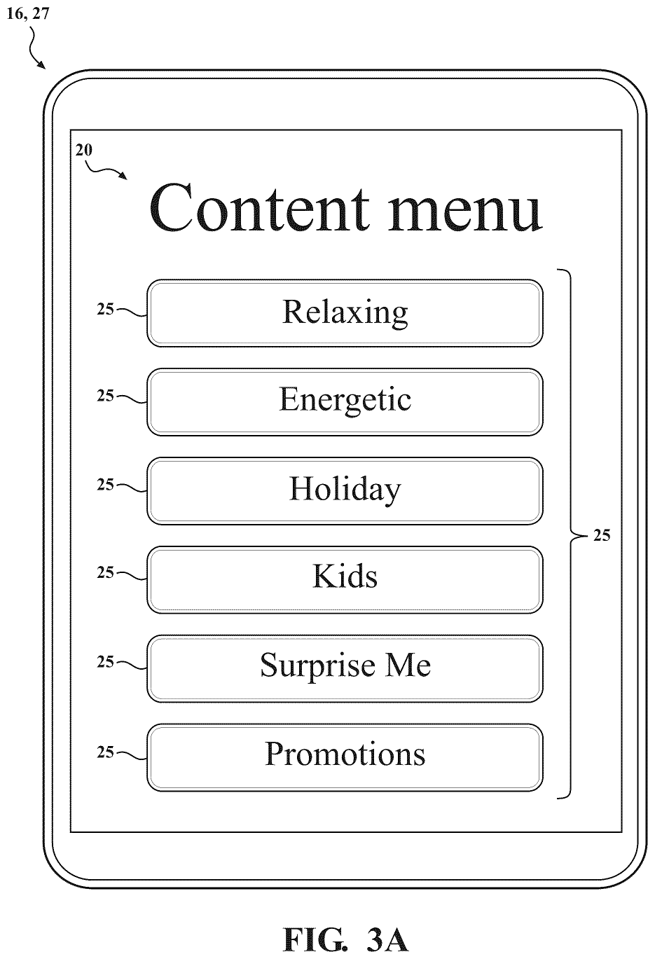

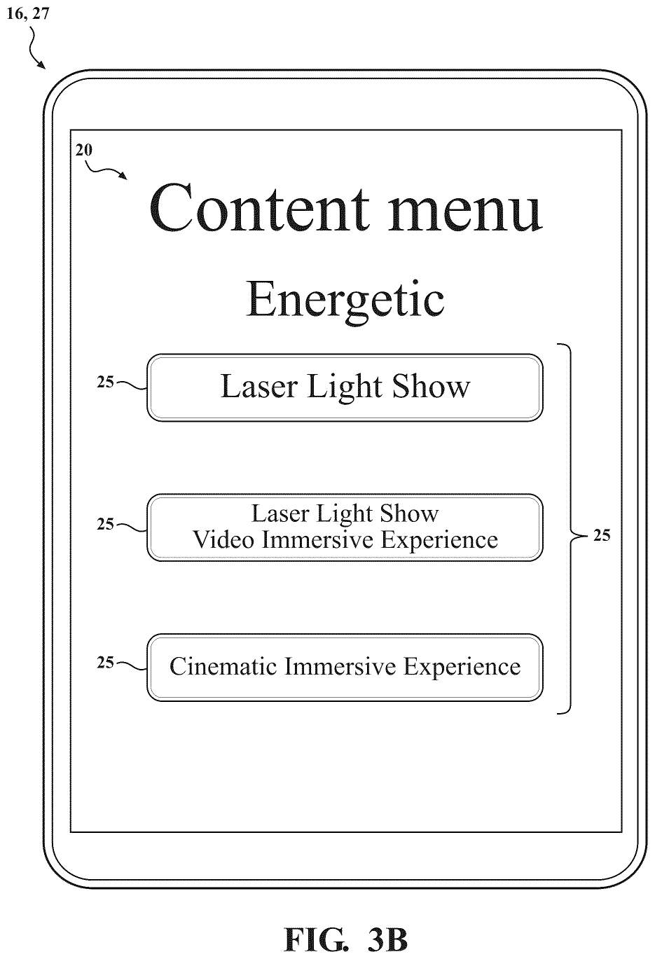

In one implementation, the user interface 16 may be a kiosk 18 located external to the carwash bay 14. The kiosk 18 is typically mounted on a pedestal adjacent to an entry path for the vehicle 12 and is positioned for convenient driver-side access. The kiosk 18 may include a weather-resistant touchscreen display and incorporate additional hardware such as a magnetic stripe or chip card reader, quick response (QR) code scanner, near field communication (NFC) module for contactless payments, and a receipt printer. The kiosk 18 is operatively connected to a control unit 26 of the carwash system 10 and allows users to interact with a content menu 20 (see FIG. 3), which presents a content selection 25. The kiosk 18 may also display previews of the selected content and provide real-time feedback on system status, estimated wash time, and promotional offers.

Additionally, or alternatively, the user interface 16 may be implemented on a cellular device 22, such as a smartphone or tablet, operated by the user. The user interface 16 may be accessed through a dedicated mobile application or a web-based platform and is configured to communicate wirelessly with the carwash system 10 via Wi-Fi, Bluetooth, or cellular data. This mobile interface provides the same content menu 20 functionality as the kiosk 18, with the added benefit of portability and remote access. Additionally, the mobile interface may support geofencing to automatically engage the system 10 upon the user's arrival.

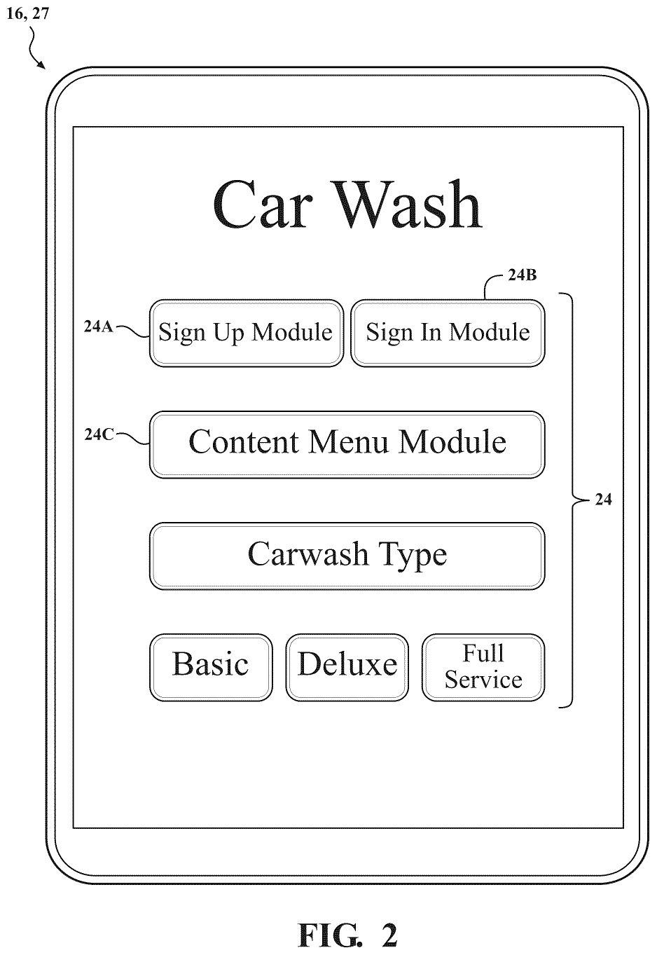

Referring now to FIG. 2, an exemplary display of the user interface 16 is shown. The user interface has several interactive modules 24 designed to enhance user engagement and personalization. It should be understood that the depiction of the interface 16 is merely schematic and intended for illustrative purposes only; the actual layout, design, and available options may vary depending on implementation.

The user interface 16 includes a signup module 24A and a sign in module 24B, enabling users to access or create a personalized account by entering identifying information. The personal account allows users to select preferred content types and optionally enroll in loyalty or promotional programs. This account may be stored on a memory storage device 27 integrated with the user interface 16 for future access. Returning users may access saved content selections 25, initiate a wash remotely, or receive system notifications and promotional messages. The user interface 16 may also allow users to schedule future washes or share their experience on social media platforms.

In some implementations, particularly when the user interface 16 is implemented on a cellular device 22, the signup process may be initiated by texting a designated number, which triggers an automated reply containing a signup link. Upon clicking the link, users may complete the signup process through a web-based interface or mobile application. The system 10 may also support Facebook-based authentication, allowing users to sign up or log in using their Facebook credentials to streamline the process and pre-fill profile information. These flexible signup methods enhance accessibility and user convenience, particularly for mobile-first users.

At the user interface 16, a user can also select the type of carwash they want from a range of predefined options, such as “Basic,” “Deluxe,” or “Full Service.” Each option corresponds to a distinct level of service, with varying combinations of wash features, treatments, and durations. These selections may be presented in a visually intuitive format, enabling users to make informed choices based on their preferences or vehicle needs. The selected wash type may be stored in the user's personalized account for future use, thereby streamlining repeat visits and enhancing overall user convenience. Upon selection of a wash type, the system's content menu module 24C facilitates the content selection process through a content menu 20 (see FIGS. 3A-3B), allowing users to further personalize their experience by choosing entertainment or informational content to accompany their wash.

As shown in FIG. 3A, the content menu Module 24C presents the user with the content menu 20, which includes a plurality of content selections 25 including selectable themes such as music genres, seasonal visuals, or promotional content. These selections may include therapeutic themes featuring calming visuals and sound frequencies, as well as an “insomniac tunnel” experience with unique content available after hours. Educational and cinematic programming may also be offered to enhance engagement and variety. The content themes may be organized into mood-based categories. Examples of some categories are “Relaxing,” “Energetic,” “Holiday,” “Kids,” or “Promotions.” For example, the “Relaxing” theme may provide a chill, dreamy, and meditative experience, while the “Energetic” theme may deliver a high-energy, upbeat, and stimulating atmosphere. A “Surprise Me” option may also be available, allowing users to receive a randomly selected theme for a novel experience. The content menu module 24C not only manages the presentation of these options but also facilitates user interaction, tracks selections, and ensures seamless content delivery.

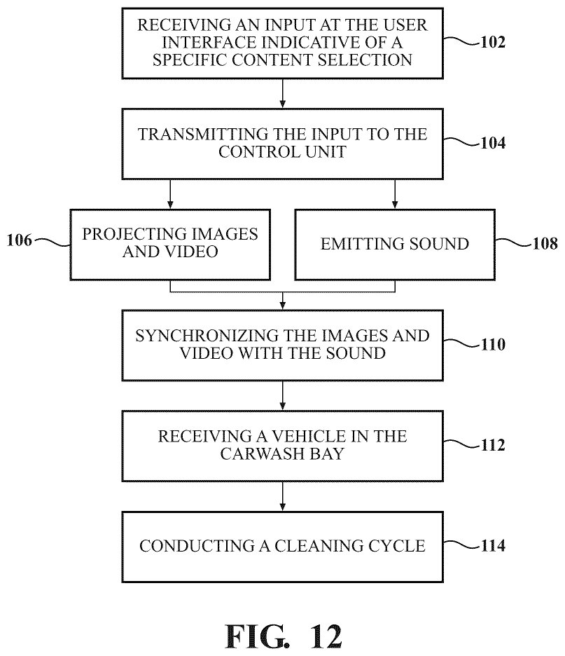

Additionally, as shown in FIG. 3A, and further in FIG. 12 which illustrates the method 100 of the system 10, upon accessing the content menu 20, the user interface 16 is configured to receive an input from the user indicative of a specific content selection 25 from the plurality of content selections 25 available (step 102), which is then transmitted to the control unit 26 (step 104) for synchronization with the carwash experience (step 110). Alternatively, users may select a desired experience by texting a corresponding product number to a designated system number, which triggers the content menu module 24C to process the content selection 25 in the same manner as if it were made through the graphical interface.

Upon receiving a valid content selection 25, the user interface 16 may initiate a payment gateway to securely process any associated transactions, such as premium content or bundled wash packages. Following successful payment, the system 10 may store the user's information-including preferences, transaction history, and selected content-on the memory storage device 27. The selected content may then be dynamically added to a personalized menu for the user, enabling a seamless and customized experience during future visits. This integration allows users to quickly reselect previously enjoyed themes or explore new offerings based on their profile. This may also enable personalized content delivery, including consumer-targeted ads and data-driven messaging tailored to customer demographics.

Moreover, upon making the specific content selection 25, the user may further customize their experience by selecting a type of show, such as a “Laser Light Show,” a “Laser Light Show Video Immersive Experience,” or an “Immersive Cinematic Experience,” each offering varying levels of entertainment and sensory engagement. For example, as shown in FIG. 3, if “Energetic” was selected by a user, a menu of the type of shows would be displayed on the content menu 20 of the user interface 16. The “Laser Light Show” may feature music and lighting effects synchronized with the movements of the wash machinery, while the “Laser Light Show Video Immersive Experience” may incorporate synchronized video imagery alongside the mechanical motion. The “Immersive Cinematic Experience” may provide a fully integrated audiovisual presentation, with both video and sound elements dynamically aligned with the wash process. These immersive options enhance the overall user experience by combining entertainment with the physical carwash environment in a coordinated and engaging manner.

A dashboard of user data module and a resources module may also be provided by the user interface 16. The user data module may be accessible to authorized personnel and provide real-time analytics on user preferences, content popularity, and system usage patterns. The user data module may also support targeted marketing campaigns or personalized content recommendations based on historical user behavior. The resources module may provide users with access to frequently asked questions (FAQs), support documentation, and/or promotional materials. For example, the resource module may include tips on how to best experience the carwash, information on how to best hear sound, and/or a share option for sharing with friends or others. This section may also include instructional videos or interactive guides to help first-time users navigate the system.

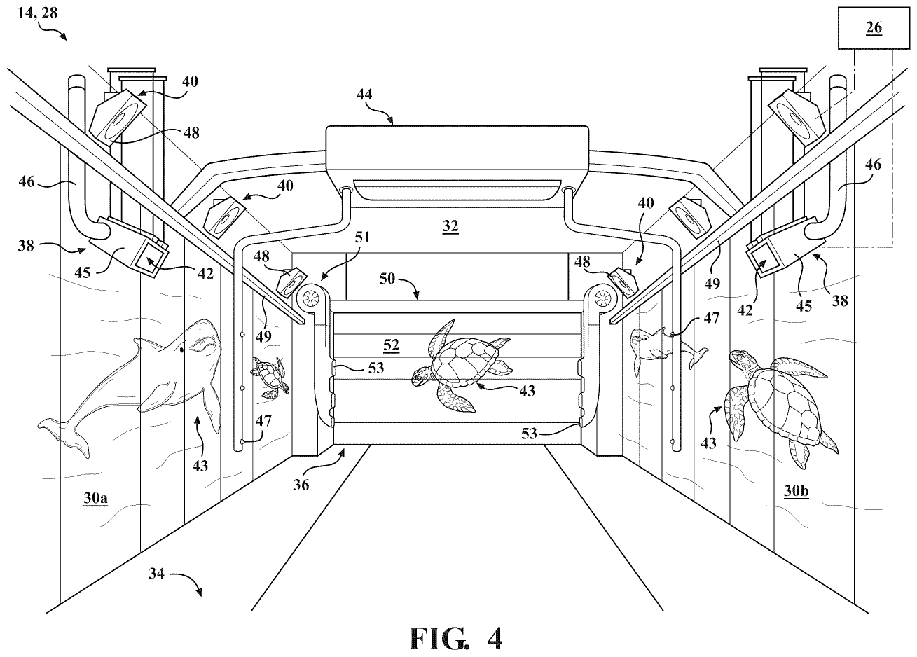

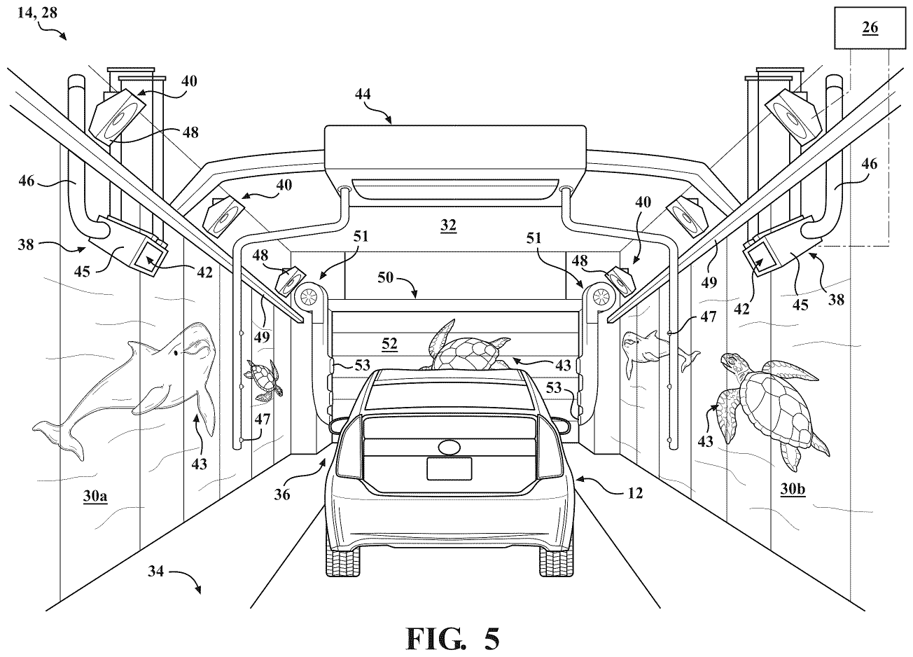

Now referring to FIGS. 4-6 and FIG. 12, an interior space 28 of the carwash bay 14 is shown. The carwash bay 14 includes a first wall 30a, a second wall 30b, a ceiling 32, an entrance area 34, and an exit area 36, all of which collectively define the interior space 28. This interior space 28 of the carwash bay 14 is configured to receive the vehicle 12 for washing (step 112). Positioned between the entrance area 34 and the exit area 36 is a designated cleaning area, where the washing unit 44 performs the primary wash operations. This cleaning area serves as the central zone for vehicle treatment and is flanked by the entrance and exit areas 34,36 to facilitate smooth vehicle 12 flow through the system 10. The carwash system 10 includes a visual projection assembly 38, an audio output system 40, and a washing unit 44, each of which are operatively connected to the control unit 26 to provide an immersive multimedia experience. It should also be understood that the carwash system 10, including its components as shown in the figures, is merely schematic and may be implemented in various configurations without departing from the scope of the invention.

The visual projection assembly 38 is mounted to the carwash bay 14 within the interior space 28 and includes one or more laser projectors 42 to project images and video 43 onto at least one of the first wall 30a and the second wall 30b (step 106) of the interior space 28. The projected content is based on the input from the user indicating their content selection 25, as received through the user interface 16. Each of the one or more laser projectors 42 is enclosed within a housing 45. Although not required, each housing 45 may include a ventilation conduit 46. The ventilation conduit 46 extends externally from the bay 14 to circulate airflow and reduce internal moisture. This can help maintain optimal operating conditions for the projector 42 components. In a high-humidity environment like the carwash bay 14, steam and mist from hot water or detergents can infiltrate unsealed enclosures. The ventilation conduit 46, helping expel moist air and draw in drier external air, reduces the risk of internal fogging, corrosion of circuit boards, or degradation of optical components. It also assists in thermal regulation, preventing overheating of the projectors' 42 internal electronics and extending the operational lifespan of the system 10.

To further enhance performance and durability, the housing 45 of each laser projector 42 may be mounted to the ceiling 32 of the carwash bay 14 to project images and video 43 across a wide area of the first and second walls 30a, 30b, thereby maximizing the immersive visual experience. Ceiling mounting ensures unobstructed projection paths, reducing the risk of shadows or interference from the vehicle 12 or wash equipment. Additionally, the ceiling 32 is the least exposed surface in a carwash bay 14 to water spray, soap, and debris. Mounting the housing 45 overhead helps protect sensitive electronics from direct contact with moisture, minimizing the risk of damage or corrosion. This elevated position also facilitates integration with the ventilation conduit 46, allowing for efficient routing of airflow and moisture control systems.

In some implementations, the visual projection assembly 38 may also support Augmented Reality (AR) features, enabling interactive and personalized overlays that respond to user preferences or vehicle movement. These AR elements may be layered onto the projected content to create a more dynamic and engaging experience.

In addition to the visual projection assembly 38, the audio output system 40 of the carwash system 10 further enhances the immersive multimedia experience within the interior space 28 of the carwash bay 14. The audio output system 40 may comprise one or more speakers 48 that emit sound based on the content selection 25 received through the user interface 16 (step 108). The control unit 26 synchronizes the audio output system 40 with the visual projection assembly 38, ensuring that the sound emitted corresponds precisely with the images and video 43 being projected (step 110). This synchronization may include music, narration, sound effects, or promotional messaging, depending on the selected theme. The one or more speakers 48 may also be mounted to the ceiling 32 of the carwash bay 14, similar to the projector housings 45, to provide optimal sound dispersion throughout the interior space 28. Ceiling mounting helps prevent obstruction by the vehicle 12 or wash equipment and protects the speakers 48 from direct exposure to water spray and debris.

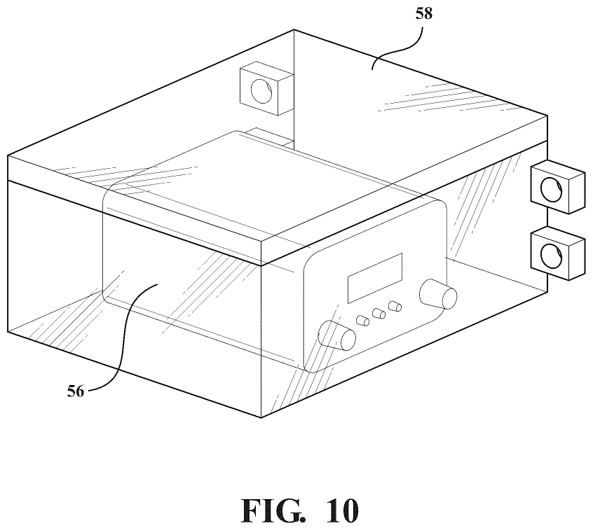

Referring to FIG. 10, the system 10 may also include a frequency modulation (FM) transmitter 56 operatively connected to the audio output system 40. The FM transmitter 56 transmits the sound from the audio output system 40 directly to a receiver within the vehicle 12, allowing customers to tune in through their car radio, fully syncing audio with the visual experience. The FM transmitter 56 may be stored within a protective enclosure 58, which may be mounted within the bay 14 or located externally, depending on installation requirements and environmental considerations.

Additionally, the system 10 may support Bluetooth transmission, enabling wireless audio playback through an onboard Bluetooth receiver of the vehicle 12. This configuration allows users to receive the synchronized sound from the content selection 25 without relying on external speakers 48, further enhancing the personalization and engagement of the carwash experience. These immersive audio experiences may also work in tandem with the external speakers 48 of the audio output system 40, providing a multi-channel sound environment that enhances the sensory impact of the carwash system 10. The combination of external speaker output, FM transmission, and Bluetooth connectivity provides flexible options for delivering immersive audio tailored to the user's selected content.

Building upon the multimedia experience provided by the visual projection assembly 38 and the audio output system 40, the washing unit 44 of the carwash system 10 plays a central role in the washing of the vehicle 12 process. The washing unit 44 is mounted between the first wall 30a and the second wall 30b and is configured to operate in both a rest mode and a cleaning mode. As depicted in FIG. 4, the washing unit 44 is shown in rest mode, indicating that a cleaning cycle has not yet been initiated. Upon receiving an input at the user interface 16 indicative of a specific content selection 25, and once the vehicle 12 is received in the carwash bay 14 (step 112), the control unit 26 activates the cleaning mode, initiating the cleaning cycle for washing the vehicle 12. The system 10 may determine that the vehicle 12 has entered the bay 14 using one or more vehicle detection mechanisms, such as infrared sensors, pressure-sensitive floor pads, ultrasonic sensors, or optical recognition systems (e.g., license plate readers or motion cameras). These sensors may be strategically positioned near the entrance area 34 and within the bay 14 to detect the presence and position of the vehicle 12 with precision.

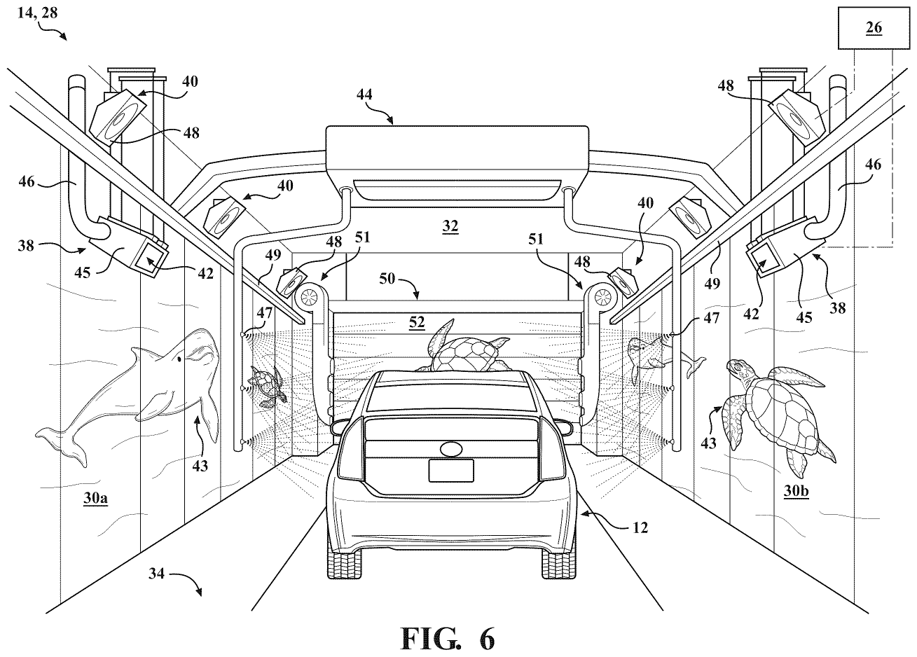

While in the cleaning mode, and while conducting the cleaning cycle (step 114), as illustrated in FIG. 6, at least a portion of the washing unit 44 moves through the cleaning area between the entrance area 34 and the exit area 36 of the carwash bay 14. This movement allows the washing unit 44 to perform a full cleaning pass over the vehicle 12. In some implementations, the washing unit 44 may be mounted overhead and supported by one or more tracks 49 secured to the first wall 30a, the second wall 30b, or the ceiling 32 of the carwash bay 14. These tracks 49 facilitate smooth and controlled movement of the washing unit 44 between the entrance area 34 and the exit area 36, enabling precise coverage during the cleaning cycle.

Additionally, the carwash system 10 may be touchless, wherein the washing unit 44 includes a plurality of sprayers 47 that apply water, soap, and other cleaning agents for washing the vehicle 12 without making physical contact with the vehicle 12. This touchless configuration not only reduces the risk of surface damage to the vehicle 12 but also helps preserve the clarity and continuity of the projected images and video 43. By eliminating mechanical contact and minimizing physical disruption within the bay, the touchless design ensures that the visual content projected onto the walls 30a, 30b remains undisturbed throughout the cleaning cycle, thereby maintaining the immersive multimedia experience for the user. It should be appreciated that the carwash system 10 could be of any suitable design or configuration without deviating from the broadest scope of the invention.

The cleaning cycle performed by the washing unit 44 is initiated and dynamically controlled based on the specific content selection 25 received through the user interface 16. Upon receiving the user's input, the control unit 26—operatively connected to the washing unit 44, the visual projection assembly 38, and the audio output system 40—coordinates the timing and execution of the cleaning cycle with the content selection 25. The control unit 26 synchronizes the projection of images and video 43 from the visual projection assembly 38 and the emission of sound from the audio output system 40 to align with the movement and operation of the washing unit 44. This synchronization ensures that the multimedia experience unfolds in harmony with the physical wash process, enhancing user engagement and creating a cohesive, immersive environment throughout the duration of the cleaning cycle.

The visual projection assembly 38 and the audio output system 40 may begin projecting images and video 43 and emitting sound prior to the initiation of the cleaning cycle, creating a pre-wash multimedia experience that engages the user before, during, and/or after the vehicle 12 enters the carwash bay 14. Additionally, or alternatively, the projecting of images and video and the emitting of sound may begin immediately upon receiving the input indicative of the specific content selection 25 at the user interface 16, and/or while the washing unit 44 is still in rest mode and prior to receiving the vehicle 12 in the carwash bay 14. During these pre-wash phases, the control unit 26 synchronizes the projected images and video 43 with the emitted sound (step 110), ensuring that the multimedia experience is cohesive even before the physical washing of the vehicle 12 begins.

Additionally, the system 10 may be configured to operate in a standalone immersive mode, allowing users to experience multimedia content without initiating a wash cycle. This feature provides an opportunity for additional revenue generation, particularly during off-peak hours or inclement weather, by offering entertainment, educational, or promotional content independently of the cleaning process.

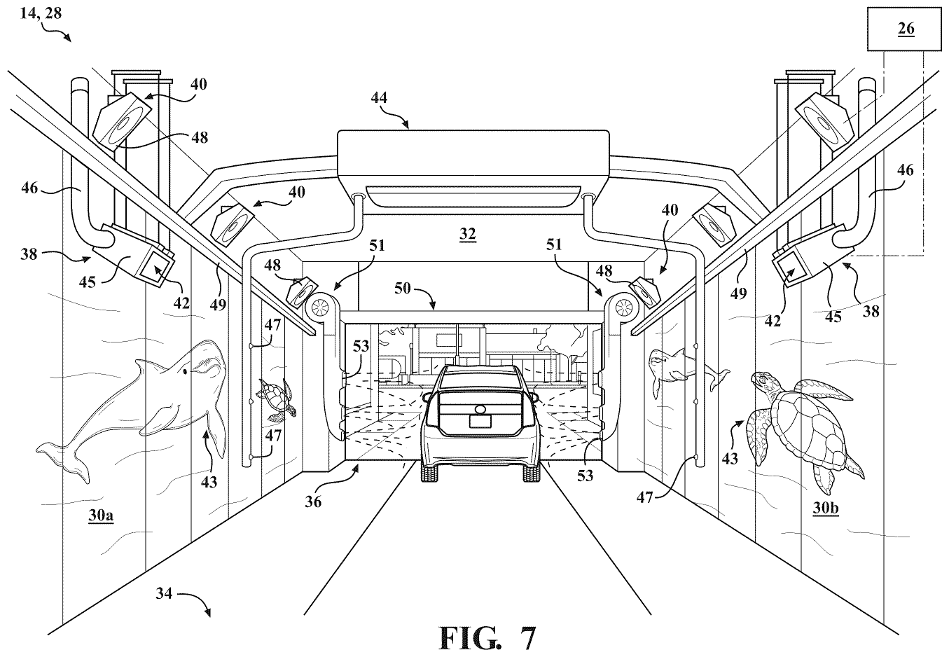

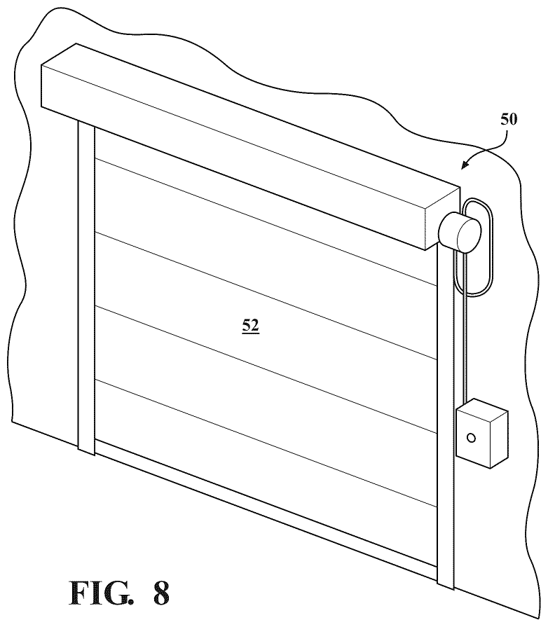

Now referring to FIGS. 7-8, to complete the immersive multimedia experience within the carwash bay 14, the exit area 36 includes an exit door 50. The exit door 50 has a display surface 52 for presenting the images and video 43 from the visual projection assembly 38. This exit door 50 may be flush-mounted, and the display surface 52 may be comprised of a paneling that is both visually neutral and highly compatible with projected content. The material may be vinyl which offers a smooth, uniform surface ideal for high-quality image projection, ensuring clarity and consistency in the visual experience. Additionally, the paneling is designed for easy replaceability, which provides significant operational advantages. In the demanding environment of a carwash bay—where exposure to moisture, cleaning agents, and debris is frequent—components are subject to wear and damage. The ability to quickly and cost-effectively replace individual panels minimizes downtime, reduces maintenance costs, and ensures the continued integrity of the multimedia display surface 52.

The exit door 50 is operatively controlled by the control unit 26 and is synchronized with the vehicle detection mechanisms and the cleaning cycle. Prior to or upon the vehicle 12 being received within the carwash bay 14, the exit door 50 may automatically close to seal the bay 14 and maintain the integrity of the multimedia environment. During the cleaning cycle, the door 50 remains closed, allowing uninterrupted projection of visual content across the walls 30a, 30b and the door 50 display surface 52 itself. Furthermore, upon completion of the cleaning cycle, the control unit 26 activates the exit door 50 to open, enabling the vehicle 12 to exit the bay 14. This coordinated operation ensures that the exit door 50 functions both as a protective barrier and as an active component of the immersive visual experience.

The exit area 36 may also include a drying system 51 configured to dry the vehicle 12 upon completion of the cleaning cycle. This system may comprise one or more high-velocity air blowers 53 mounted near the exit door 50 or along the ceiling 32, positioned to direct airflow across the vehicle's surface as it moves through the exit area 36. The drying system 51 enhances the overall wash experience by ensuring the vehicle 12 exits clean and dry, while maintaining the immersive environment through synchronized operation with the control unit 26.

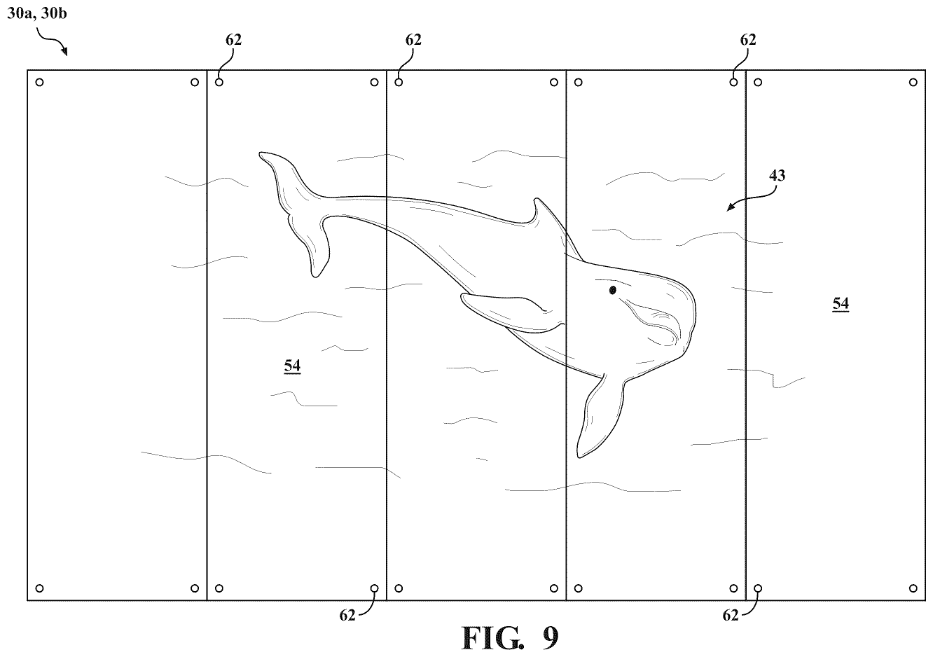

Now referring to FIG. 9, the first wall 30a and the second wall 30b of the carwash bay 14 may include removable paneling 54 for facilitating cleaning or replacement of wall surfaces to maintain clarity of projected images and video 43 from said visual projection assembly 38. The paneling 54 may be comprised of high-density polyethylene (HDPE), a flexible material well-suited for the demanding conditions of a carwash environment due to its durability, chemical resistance, and water-repellent properties. HDPE provides a smooth, uniform surface ideal for high-quality image projection, contributing to the immersive multimedia experience. The flexibility of HDPE allows the panels to absorb minor impacts without cracking or deforming, preserving the integrity of the display surface.

To enable secure installation and easy removal, the paneling 54 may be fastened to the walls using mechanical fasteners 62 such as corrosion-resistant screws, snap-in clips, or quick-release brackets. These fastening methods allow for efficient replacement of the paneling 54 or cleaning of the paneling 54 without requiring specialized tools or extensive disassembly. In the event of damage, discoloration, or buildup that could interfere with projection clarity, individual panels of the paneling 54 can be quickly swapped out, minimizing downtime and preserving the visual performance of the system. This modular and maintainable design ensures long-term operational efficiency and supports the continued delivery of a high-quality, immersive multimedia experience within the carwash system 10.

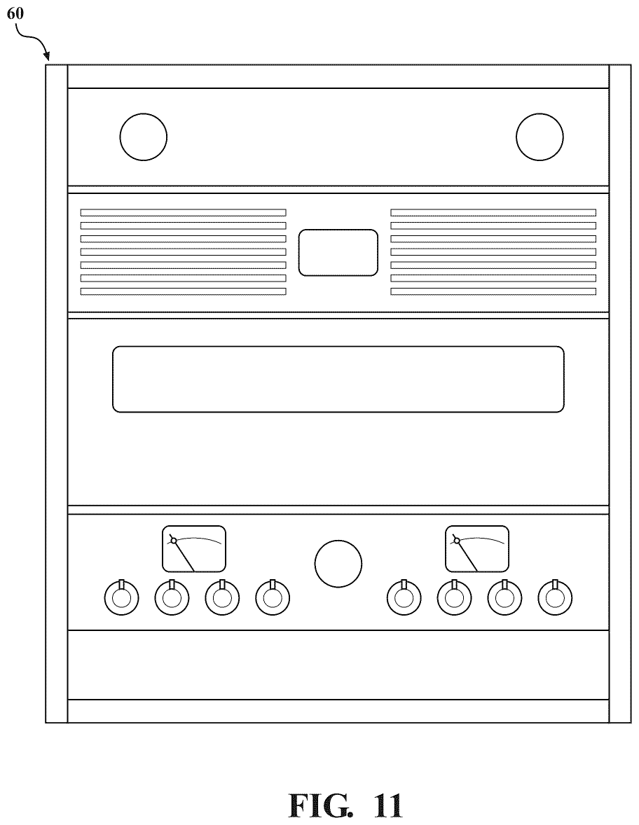

As shown in FIG. 11, the carwash system 10 may further include an amplifier 60 operatively connected to the audio output system 40 to enhance sound quality and volume throughout the interior space 28 of the carwash bay 14. The amplifier 60 receives audio signals from the control unit 26, which synchronizes sound with the visual content projected by the visual projection assembly 38. By boosting the audio signal before it reaches the one or more speakers 48, the amplifier 60 ensures that music, narration, sound effects, or promotional messaging are delivered with clarity and sufficient volume, even in the acoustically challenging environment of a carwash bay. This is particularly beneficial in overcoming ambient noise from wash equipment, water spray, and vehicle movement. The inclusion of an amplifier 60 also supports a more immersive multimedia experience by maintaining consistent audio fidelity and dynamic range, allowing users to fully engage with the themed content selection 25 throughout the cleaning cycle. Additionally, the amplifier 60 may be configured to adjust output levels based on the selected theme or user preferences, further enhancing the personalization and impact of the carwash experience.

Several implementations/aspects have been discussed in the foregoing description. However, the implementations discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described. The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A carwash system for washing a vehicle, said system comprising:
a carwash bay having a first wall, a second wall, a ceiling, an entrance area, and an exit area defining an interior space;
a visual projection assembly mounted to said carwash bay within said interior space to project images and video onto at least one of said first wall and said second wall within said interior space;
an audio output system mounted to said carwash bay to emit sound within said interior space;
a user interface having a content menu with a plurality of content selections wherein the user interface is configured to receive an input indicative of a specific content selection from said content menu;
a washing unit mounted between said first wall and said second wall with said washing unit having a rest mode and a cleaning mode with at least a portion of said washing unit moving between said entrance area and said exit area when in the cleaning mode to conduct a cleaning cycle for washing the vehicle; and
a control unit operatively connected to said visual projection assembly, said audio output system, said user interface, and said washing unit with said control unit synchronizing said visual projection assembly and said audio output system with said cleaning cycle based on said content selection from said input received on said user interface.

2. The carwash system of claim 1, wherein said visual projection assembly projects images and video and said audio output system emits sound prior to an initiation of said cleaning cycle.

3. The carwash system of claim 1, wherein said visual projection assembly projects images and video and said audio output system emits sound immediately upon receiving said input indicative of said specific content selection at said user interface.

4. The carwash system of claim 1, wherein said visual projection assembly projects images and video and said audio output system emits sound while said washing unit is in said rest mode and prior to receiving the vehicle in the carwash bay for washing.

5. The carwash system of claim 1, wherein said control unit synchronizes said images and video with said sound while said washing unit is in said rest mode.

6. The carwash system of claim 1, wherein said carwash system is touchless with said washing unit having a plurality of sprayers to perform said cleaning cycle for washing the vehicle without physical contact.

7. The carwash system of claim 1, wherein said visual projection assembly includes one or more laser projectors with each of said one or more laser projectors enclosed within a housing having a ventilation conduit that extends externally to said carwash bay for circulating air flow and reducing moisture within said housing.

8. The carwash system of claim 7, wherein said housing of said one or more laser projectors is mounted to said ceiling of said carwash bay.

9. The carwash system of claim 1, wherein said audio output system includes one or more speakers mounted to said ceiling of said carwash bay.

10. The carwash system of claim 1, wherein said first wall and said second wall have removable paneling to facilitate at least one of cleaning and replacement of wall surfaces to maintain clarity of projected images and video from said visual projection assembly.

11. The carwash system of claim 1, wherein said exit area includes an exit door with a display surface to present said images and video from said visual projection assembly.

12. The carwash system of claim 1, wherein said user interface is at least one of a cellular device and a kiosk.

13. The carwash system of claim 1, wherein said plurality of content selections includes selectable themes comprising music genres, seasonal visuals, or promotional content.

14. The carwash system of claim 1, further comprising a memory storage device integrated with said user interface to store said specific content selection of a user for future use.

15. The carwash system of claim 1, further comprising an FM transmitter operatively connected to said audio output system for transmitting said sound to a receiver within the vehicle.

16. A method of operating a carwash system for washing a vehicle having a carwash bay with a first wall, a second wall, a ceiling, an entrance area, and an exit area to define an interior space, the carwash system also including a visual projection assembly, an audio output system, a washing unit having a rest mode and a cleaning mode, a user interface having a content menu with a plurality of content selections, and a control unit operatively connected to said visual projection assembly, said audio output system, said user interface, and said washing unit, said method comprising the steps of:
receiving an input at the user interface indicative of a specific content selection from the plurality of content selections of the content menu;
transmitting the input indicative of the content selection from the user interface to the control unit;
projecting images and video with the visual projection assembly onto at least one of the first wall and the second wall within the interior space based on the content selection;
emitting sound with the audio output system based on the content selection;
synchronizing with the control unit the images and video projected from the projection assembly and the sound emitted from the audio output system;
receiving a vehicle in the carwash bay; and
conducting a cleaning cycle for washing the vehicle with at least a portion of the washing unit moving between the entrance area and the exit area when the cleaning mode of the washing unit is activated based on the content selection from the input at the user interface.

17. The method of claim 16, wherein the steps of projecting images and video with the visual projection assembly and emitting sound with the audio output system occurs prior to the conducting of said cleaning cycle.

18. The method of claim 16, wherein the steps of projecting images and video with the visual projection assembly and emitting sound with the audio output system occurs immediately upon receiving said input indicative of said specific content selection at said user interface.

19. The method of claim 16, wherein the steps of projecting images and video with the visual projection assembly and emitting sound with the audio output system occur prior to receiving the vehicle in the carwash bay and while the washing unit is in rest mode.

20. The method of claim 16, wherein the step of synchronizing with the control unit further includes synchronizing the cleaning cycle with the images and video projected from the projection assembly and the sound emitted from the audio output system.

21. The method of claim 16, further comprising the step of transmitting with an FM transmitter the sound from the audio output system to a receiver within the vehicle.
